(19) United States
(12) Patent Application Publication
(10) Pub. No.: US 2002/0183086 A1
(43) Pub. Date: Dec. 5, 2002

(54) Technique for improving open loop power control in spread spectrum telecommunications systems

(76) Inventors: Martin Hellmark, Lund (SE); Kjell Gustafsson, Lund (SE); Torgny Palenius, Loddekopinge (SE); Torsten Carlsson, Lund (SE)

Correspondence Address: Jenkens & Gilchrist, P.C., Suite 3200, 1445 Ross Avenue, Dallas, TX, 75202, US

(21) Appl. No.: 09/874,579

(22) Filed: Jun. 4, 2001

(51) Int. Cl. H04B 7/00

(52) U.S. Cl. 455/522; 455/69

(57) ABSTRACT

A technique for improving open loop power control in spread spectrum telecommunications systems is disclosed. In a preferred embodiment, the technique is realized by transmitting at least one first access channel probe for a first message from a mobile station to a base station, wherein the transmission power level of each access channel probe in the at least one first access channel probe is increased until a base station acknowledgment is received for a specific access channel probe of the at least one first access channel probe at a first transmission power level. The first transmission power level is then stored at the mobile station. At least one second access channel probe for a second message is then transmitted from the mobile station to the base station, wherein the transmission power level of an initial access channel probe of the at least one second access channel probe for the second message is based upon the first transmission power level.

### FIELD OF THE INVENTION

The present invention relates generally to telecommunications systems and, more particularly, to a technique for improving open loop power control in spread spectrum telecommunications systems.

### BACKGROUND OF THE INVENTION

In the field of cellular telecommunications, during the past few years, efforts have been directed towards developing spread spectrum or Code Division Multiple Access (CDMA) systems. In a CDMA system, multiple users, each using a channel identified by a uniquely assigned digital code, simultaneously communicate with the system while sharing the same wideband frequency spectrum.

CDMA systems provide several advantages over conventional frequency division multiple access (FDMA) or time division multiple access (TDMA) systems. In FDMA systems, users are assigned a unique frequency for mobile to base (uplink or reverse link) and base to mobile (downlink or forward link) communications. In TDMA systems, users are each assigned a unique frequency, for the uplink and downlink, and a unique time period in which to transmit or receive on that frequency. These FDMA and TDMA systems require planning for allocation of channel frequencies and/or time periods on these channel frequencies to mobile stations and base stations. In a CDMA system, however, frequency and time period assignment planning for mobile stations and base stations is not necessary, as in FDMA and TDMA systems, because all CDMA base stations share the entire downlink frequency spectrum, and all mobiles share the entire uplink frequency spectrum. The fact that the wideband frequency spectrum is shared by all uplink or downlink users in a CDMA system also increases capacity, since the number of users that can be multiplexed simultaneously is only limited by the number of digital codes available to identify the unique communications channels of the system, and by the total interference caused by the other users sharing the same spectrum, and not by the number of radio frequency channels available. Additionally, since the energy of the transmitted signals are spread over the wideband uplink or downlink frequency band, selective frequency fading does not affect the entire CDMA signal.

In a CDMA system, the transmission power levels of mobile stations are important. That is, signals from many different mobile stations are simultaneously received at the same frequency at a base station, and, because of the nature of CDMA demodulation, it is necessary that the signal received at the base station from each mobile station be as close as possible to a single predetermined power level so that the signal from one mobile station does not overwhelm the signal from another mobile station (i.e., a near-far problem). Thus, in a CDMA system, a power control process is typically used to control each mobile station's transmission power level so that the signal level received at the base station from each mobile station is as close as possible to a single predetermined power level. The requirements of one, exemplary CDMA mobile station power control process are specified in the Telecommunications Industry Association/Electronic Industries Association (TIA/EIA) IS-95 standard.

In a typical power control process in a CDMA system, a mobile station adjusts its transmission power level in an access channel, that has been assigned by a base station, through which the mobile station is attempting to gain access to the system. To gain access, the mobile station follows an open loop power control process that involves transmitting access channel probe transmissions at a relatively low power level on the access channel, and then gradually increasing the power level of subsequent access channel probe transmissions in access channel probe correction increments set by the system until a response is obtained from the system and the mobile station gains access to the system. Generally, the power level at which a mobile station initiates access channel probe transmissions is determined by estimating the path loss to the base station, and knowing what the interference level is at the base station (typically sent as a layer 3 message to the mobile station). Path loss is estimated by knowing the base station power (also typically sent as a layer 3 message to the mobile station), and measuring the Received Signal Code Power (RSCP) at the mobile station. That is, a control channel such as, for example, a Common Pilot Channel (CPICH), is received with a code power (RSCP) which can be measured by the mobile station. As such, the accuracy of the power level at which a mobile station performs access channel probe transmissions is generally determined by: 1) how accurately the received code power (e.g., RSCP) can be estimated; and 2) how accurately the transmitting power amplifier can be controlled.

A significant problem with the above-described open loop power control approach is that it is inefficient and costly in terms of increased response time and reduced data transmission throughput. In other words, the above-described open loop power control approach involves the transmission of access channel probes at a relatively low power level on the access channel, and then gradually increasing the power level of subsequent access channel probe transmissions until a response is obtained from the network. Consequently, it can take a relatively long time for the power level to reach the point where the base station is able to detect the access channel probe transmissions. As such, it can take a relatively long time before the base station is able to respond to the access channel probe transmissions, which increases the time it takes for the mobile station to access the network. This is particularly problematic in the case of packet mode transmissions wherein the above-described open loop power control random access process has to be frequently repeated for every packet. Any inaccuracy in the random access power decreases the packet data throughput.

In view of the foregoing, it is desirable to provide a modified open loop power control method and system which overcomes the above-described inadequacies and shortcomings. More particularly, it would be desirable to provide an efficient and cost effective method and system for improving open loop power control in spread spectrum or CDMA mobile telecommunication systems.

### OBJECTS OF THE INVENTION

The primary object of the present invention is to provide a technique for improving open loop power control in spread spectrum telecommunication systems.

The above-stated primary object, as well as other objects, features, and advantages, of the present invention will become readily apparent to those of ordinary skill in the art from the following summary and detailed descriptions, as well as the appended drawings. While the present invention is described below with reference to preferred embodiment(s), it should be understood that the present invention is not limited thereto. Those of ordinary skill in the art having access to the teachings herein will recognize additional implementations, modifications, and embodiments, as well as other fields of use, which are within the scope of the present invention as disclosed and claimed herein, and with respect to which the present invention could be of significant utility.

### SUMMARY OF THE INVENTION

According to the present invention, a method and system for improving open loop power control in spread spectrum telecommunication systems is provided. In a preferred embodiment, the method is realized by transmitting at least one first access channel probe for a first message from a mobile station to a base station, wherein the transmission power level of each access channel probe in the at least one first access channel probe is increased until a base station acknowledgment is received for a specific access channel probe of the at least one first access channel probe at a first transmission power level. The first transmission power level is then stored at the mobile station. At least one second access channel probe for a second message is then transmitted from the mobile station to the base station, wherein the transmission power level of an initial access channel probe of the at least one second access channel probe for the second message is based upon the first transmission power level. The first message can be, for example, a first packet in a packet mode transmission, and the second message can be a second packet in a packet mode transmission.

In accordance with other aspects of the present invention, a recently measured code power value received from the base station is stored at the mobile station, wherein the transmission power level of the initial access channel probe of the at least one second access channel probe for the second message is further based upon the recently measured received code power.

In accordance with other aspects of the present invention, a recently measured base station interference level value is stored at the mobile station, wherein the transmission power level of the initial access channel probe of the at least one second access channel probe for the second message is further based upon the recently measured base station interference level.

In accordance with further aspects of the present invention, the transmission power level of an initial access channel probe of the at least one first access channel probe for the first message is based upon a path loss between the mobile station and the base station. The transmission power level of an initial access channel probe of the at least one first access channel probe for the first message may be further based upon a base station interference level.

In accordance with still further aspects of the present invention, the transmission power level of the initial access channel probe of the at least one second access channel probe for the second message is closer to the first transmission power level than a transmission power level of an initial access channel probe of the at least one first access channel probe for the first message. Also, the transmission power level of the initial access channel probe of the at least one second access channel probe for the second message is closer to a transmission power level that is required to have the initial access channel probe reach the base station than a transmission power level of an initial access channel probe of the at least one first access channel probe for the first message. Alternatively, the transmission power level of the initial access channel probe of the at least one second access channel probe for the second message is at or slightly above a transmission power level that is required to have the initial access channel probe reach the base station.

The present invention will now be described in more detail with reference to exemplary embodiments thereof as shown in the appended drawings.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram of an exemplary telecommunication system constructed according to an embodiment of the present invention.

FIG. 2 is a block diagram of portions of an exemplary CDMA mobile station that is constructed and operated according to an embodiment of the present invention.

FIG. 3 is a block diagram of portions of an exemplary CDMA base station that is constructed and operated according to an embodiment of the present invention.

FIG. 4 is an exemplary diagram that illustrates how the present invention solves the existing open loop power control problem.

FIG. 5 is a flowchart diagram illustrating an exemplary modified open loop power control method that can be used to implement an embodiment of the present invention.

### DETAILED DESCRIPTION OF EXEMPLARY EMBODIMENT(S)

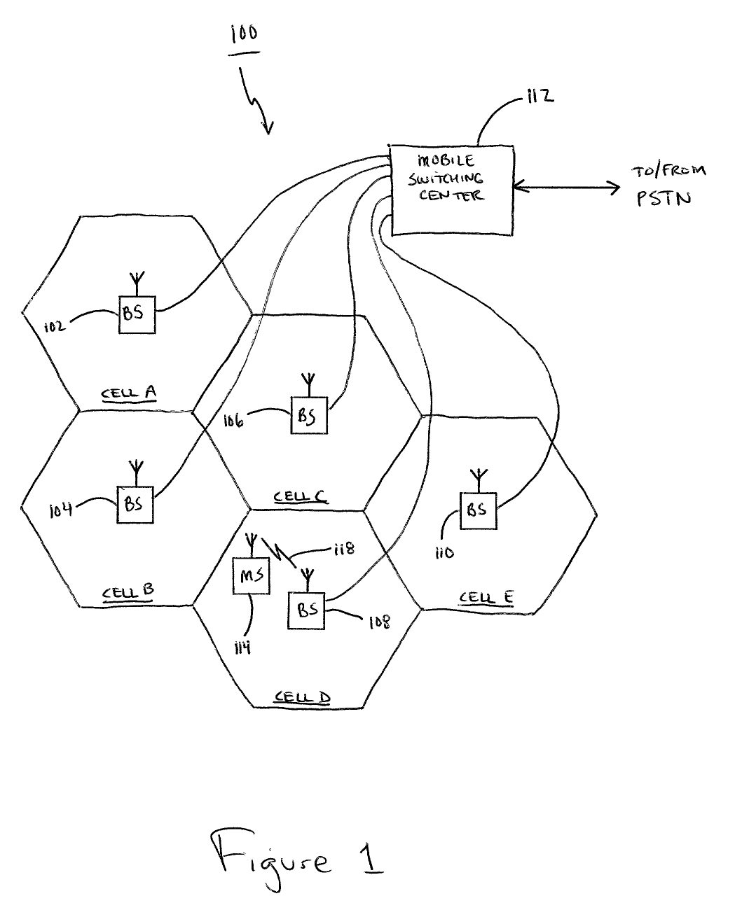

Referring to FIG. 1, there is shown a block diagram of an exemplary cellular telecommunication system 100 constructed according to an embodiment of the present invention. The cellular telecommunications system 100 comprises a mobile station (MS) 114 and a cellular telecommunications system infrastructure comprising a mobile switching center (MSC) 112 and a plurality of base stations (BS) 102, 104, 106, 108 and 110. Each of the base stations 102, 104, 106, 108 and 110 provide coverage over a separate area of the cellular telecommunications system 100, shown as cell A, cell B, cell C, cell D, and cell E, respectively, in FIG. 1. Thus, a subscriber who subscribes to service provided by the operator of the cellular telecommunications system 100 may use the mobile station 114 to make and receive phone calls over a radio interface between the mobile station 114 and a base station, such as is shown by the radio interface 118 between the mobile station 114 and the base station 108, as the subscriber moves throughout the coverage area of the cellular telecommunications system 100.

The base stations 102, 104, 106, 108 and 110 are connected to the mobile switching center 112 as in a conventional cellular telecommunications system (e.g., via landlines). The mobile switching center 112 is connected to a public switched telephone network (PSTN) so as to allow subscribers of the cellular telecommunications system 100 to make and receive phone calls to and from the public switched telephone network.

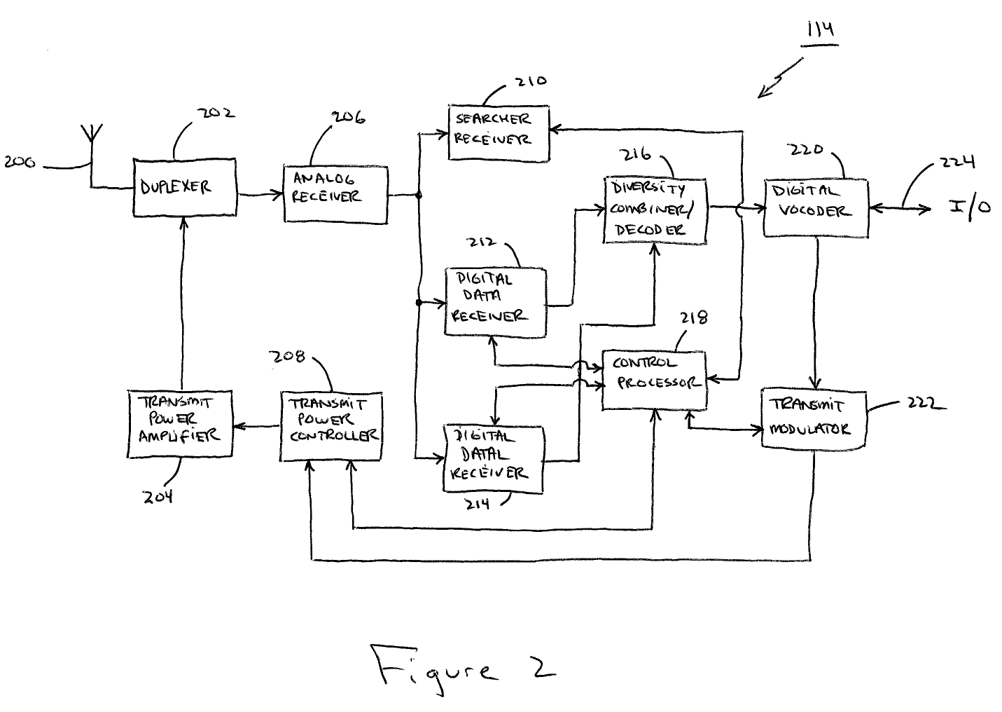

Referring now to FIG. 2, there is shown a block diagram of portions of an exemplary mobile station (e.g., mobile station 114), which can be used to implement an embodiment of the invention. As shown, the exemplary mobile station 114 comprises an antenna 200, a duplexer 202, a transmit power amplifier 204, an analog receiver 206, a transmit power controller 208, a searcher receiver 210, a digital data receiver 212, a digital data receiver 214, a diversity combiner/decoder 216, a control processor 218, a user digital vocoder 220, a transmit modulator 222, and a user interface 224.

The antenna 200 is coupled to the analog receiver 206 through the duplexer 202. Signals received at the antenna 200 are input to the analog receiver 206 through the duplexer 202. The received signals are converted to an IF frequency and then filtered and digitized in the analog receiver 206 for input to the digital data receiver 212, the digital data receiver 214, and the searcher receiver 210. The digitized IF signal input to the digital data receiver 212, the digital data receiver 214, and the searcher receiver 210 may include signals from many ongoing calls together with the pilot carriers transmitted by the base station of the cell site in which the mobile station 114 is currently located, plus the pilot carriers transmitted by the base stations in all neighboring cell sites. The digital data receiver 212 and the digital data receiver 214 perform correlation on the IF signal with a psuedorandom noise (PN) sequence of a desired received signal. The output of the digital data receivers 212 and 214 is a sequence of encoded data signals from two independent paths. The searcher receiver 210 scans the time domain around the nominal time of a received pilot signal of a base station for other multi-path pilot signals from the same base station and for other signals transmitted from different base stations. The searcher receiver 210 measures the strength of any desired waveform at times other than the nominal time. The searcher receiver 210 generates signals to the control processor 218 indicating the strengths of the measured signals.

The encoded data signals output from the digital data receiver 212 and the digital data receiver 214 are input to the diversity combiner/decoder 216. In the diversity combiner/decoder 216 the encoded data signals are aligned and combined, and the resultant data signal is then decoded using error correction and input to the digital vocoder 220. The digital vocoder 220 then outputs information signals to the user interface 224. The user interface 224 may be a handset with a keypad, or another type of user interface such as, for example, a laptop computer monitor and keyboard.

For transmission of signals from the mobile station 114, a signal received at the user interface 224 is input to the digital vocoder 220 in digital form, such as, for example, data or voice that has been converted into digital form at the user interface 224. In the digital vocoder 220, the signal is encoded and output to the transmit modulator 222. The transmit modulator 222 Walsh encodes the signal and then modulates the Walsh encoded signal onto a PN carrier signal, with the PN carrier sequence being the PN carrier sequence of the CDMA channel to which the mobile station 114 is assigned. The PN carrier information is transmitted to the mobile station 114 from the system 100 and is transferred to the control processor 218 from the digital data receivers 212 and 214 after being received from the system 100. The control processor 218 sends the PN carrier information to the transmit modulator 222. The PN modulated signal is then output from the transmit modulator 222 to the transmit power controller 208.

The transmit power controller 208 sets the level of the transmission power of the mobile station 114 according to commands received from the control processor 218. The power control commands may be generated by the control processor 218 according to commands received from the system 100 or may be generated by software of the control processor 218, according to predetermined criteria, typically in response to data received from the system 100 through the digital data receivers 212 and 214. The modulated signal is then output from the transmit power controller 208 to the transmit power amplifier 204 where the signal is amplified and converted to a radio frequency (RF) transmission signal. The RF transmission signal is then output from the transmit power amplifier 204 to the duplexer 202 and is transmitted from the antenna 200.

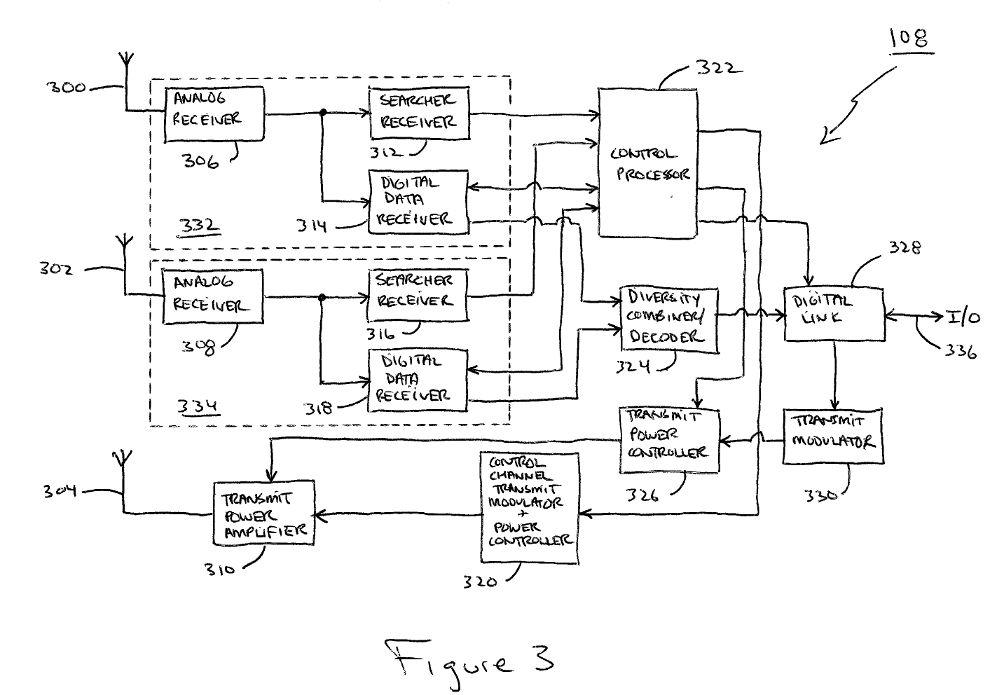

Referring now to FIG. 3, there is shown a block diagram of portions of an exemplary base station (e.g., base station 108), which can be used to implement an embodiment of the invention. As such, the block diagrams of any of the other base stations 102, 104, 106, and 110 may be equivalent to that shown in FIG. 3 for the base station 108. As shown, the exemplary base station 108 comprises a first receiver section 332, a second receiver section 334, a control processor 322, a diversity combiner/decoder 324, a transmit power controller 326, a digital link 328, a transmit modulator 330, a control channel transmit modulator/power controller 320, a transmit power amplifier 310, and an antenna 304. The first receiver section 332 comprises an antenna 300, an analog receiver 306, a searcher receiver 312, and a digital data receiver 314. The second receiver section 334 comprises an antenna 302, an analog receiver 308, a searcher receiver 316, and a digital data receiver 318.

The first receiver section 332 and the second receiver section 334 provide space diversity for a single signal that may be received at both of the antennas 300 and 302. The signals received at the antenna 300 are input to the analog receiver 306 where the signal is filtered, converted to an IF frequency, and digitized to generate a digital signal. The digital signal is then output from the analog receiver 306 to the searcher receiver 312 and the digital data receiver 314. The searcher receiver 312 scans the time domain around the received signal to verify that the digital data receiver 314 tracks the correct signal. The control processor 322 generates the control signals for the digital data receiver 314, according to a signal received from the searcher receiver 312, so that the correct signal is received at the digital data receiver 314. The digital data receiver 314 generates the proper PN sequence necessary to decode the digital signal received from the analog receiver 306 and generates weighted output symbols for input to the diversity combiner/decoder 324. The antenna 302, the analog receiver 308, the searcher receiver 316, and the digital data receiver 318 of the second receiver section 334 function identically to the components of the first receiver section 332 to generate a second set of weighted output symbols. The weighted symbols from the digital data receiver 314 and the digital data receiver 318 are then combined and decoded in the diversity combiner/decoder 324 to generate received digital data, which is then output through the digital link 328 to the mobile switching center 112 of FIG. 1.

Essentially, the present invention provides a solution to the above-described problems by modifying the existing open loop power control method so that a more intelligent estimate can be made for the required power level of the access channel probe transmissions, as described in detail below. For ease in understanding the following description of an exemplary embodiment of the present invention, it can be assumed that the mobile station is attempting packet mode transmissions. It should be noted, however, that the present invention is not intended to be limited in this regard.

In accordance with the present invention, a first option modifies an existing open loop power control method so that a typical “slow” access channel probe sequence is performed for a first packet (packet 1) in a sequence of packets. That is, a typical open loop power control method is followed for a first packet (packet 1) in a sequence of packets such that access channel probe transmissions are transmitted at a relatively low power level on the access channel, and then the power level of subsequent access channel probe transmissions is gradually increased until a response is obtained from the system. The power level that was used to successfully obtain a response from the system for the first packet (packet 1) is then stored. For example, this power level can be in the form of a direct power value, or, alternatively, in the form of a voltage value which was applied to a variable gain amplifier (VGA) in the transmit power amplifier 204. The value of a received code power (e.g., RSCP) is also stored (i.e., the pilot channel, or some other control channel such as, for example, a broadcast control channel, which the mobile receives with a code power that can be measured by the mobile station). Thus, this measured received code power can be stored along with the transmitted power level of the first packet (packet 1).

Next, an access channel probe sequence is performed for a second packet (packet 2) in the sequence of packets, based upon the power level that was used to successfully obtain a response from the system for the first packet (packet 1), and the received code power (e.g., RSCP) that was measured just before the transmission of the second packet (packet 2). That is, instead of basing the transmission power level of the access channel probe sequence for the second packet (packet 2) in the sequence of packets on path loss and interference, as would be the case with the prior art methods, in accordance with the invention, the transmission power level of the access channel probe sequence for the second packet (packet 2) in the sequence of packets is based upon the power level that was used to successfully obtain a response from the system for the first packet (packet 1) and the received code power that was measured just before the transmission of the access channel probe sequence for the second packet (packet 2) in the sequence of packets. The interference level at the base station can be taken into account as well. That is, the pilot channel, or some other control channel such as, for example, a broadcast control channel, generally includes an indication of the base station interference level which can be measured by the mobile station. Thus, in addition to the transmitted power level of the first packet (packet 1) and the recently measured received code power, this measured interference level can also be used to determine the appropriate transmission power level of the access channel probe sequence for the second packet (packet 2) in the sequence of packets.

At this point it should be noted that the determination of the appropriate transmission power level of the access channel probe sequence for the second packet (packet 2) in the sequence of packets can be performed, for example, by the control processor 218, which then transmits power control commands to the transmit power controller 208. The power control commands can be generated from software algorithms being executed by the control processor 218, based upon the transmitted power level of the first packet (packet 1), the recently measured received code power (e.g., RSCP), and/or the recently measured interference level. In accordance with the power control commands, the transmit power controller 208 outputs an appropriate modulated signal to the transmit power amplifier 204, where the modulated signal is amplified and converted to an RF transmission signal. The RF transmission signal is then output from the transmit power amplifier 204 to the duplexer 202 and is transmitted from the antenna 200.

The precise method for determining the transmission power level of the access channel probe sequence for the second packet (packet 2), and all subsequent packets, in the sequence of packets may vary depending upon the weight given to any of the above-discussed factors used in determining the transmission power level of the access channel probe sequence for the second packet (packet 2), and all subsequent packets, in the sequence of packets. For example, the transmission power level of the access channel probe sequence for the second packet (packet 2), and all subsequent packets in the sequence of packets, can merely be set at a power level which is closer to the power level that is actually required than would have been obtained using the traditional power level determination method (i.e., based on path loss and interference). This “closer” power level, which is determined by taking into account the transmitted power level of the first packet (packet 1), the recently measured received code power, and/or the recently measured interference level, can then be used in a typical “slow” access channel probe sequence. Some margin for inaccuracy is preferably included in this “closer” power level.

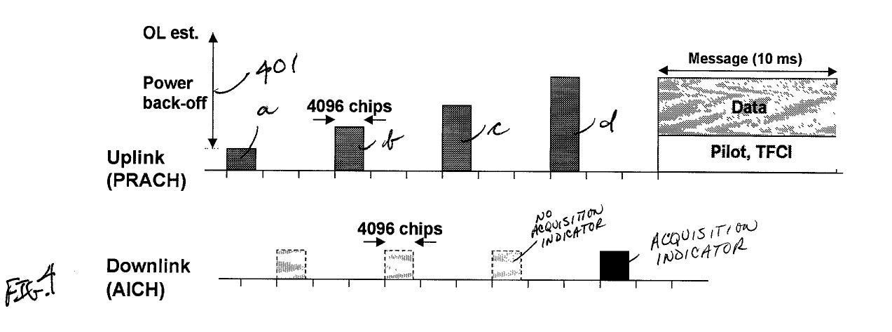

FIG. 4 is an exemplary diagram that illustrates how the present invention solves the existing open loop power control problem described above. Referring to FIG. 4, it can be seen that a mobile station is ramping up or increasing its transmission power level on, for example, a Packet Random Access Channel (PRACH), for successive packets (e.g., preambles a-d). The uncertainty in determining what uplink power should be transmitted can be characterized by the difference 401 between the Open Loop (OL) estimate made and the Power back-off value. The present invention strives to minimize this difference (401) so that the determined OL estimate is closer to a final value than any prior art solutions.

As an alternative method (option 2), the transmission power level of the second packet (packet 2), and all subsequent packets, in the sequence of packets can be set at a power level which is at, or even slightly above, the exact required power level, as determined by taking into account the transmitted power level of the first packet (packet 1), the recently measured received code power, and/or the recently measured interference level. In other words, the packet should be transmitted with a high enough power level to result in a high probability of an accepted packet reception. This method essentially ensures that the second packet (packet 2), and all subsequent packets, in the sequence of packets will reach the base station. However, this method of determining the power level should be relatively accurate to avoid increased interference.

A third option is to use a combination of the two methods just described. The choice of which method to use is based on how much the channel environment has changed since the last access channel probe sequence. The change in environment is detected by looking at changes in the measured received code power, and changes in the measured base station interference level. The advantage of the first method described above is that basically no change has to be made to the access channel probe algorithms. That is, a mobile station can only perform better estimates, and such a mobile station that performs better estimates achieves higher packet throughput. The advantage of the second method described above is that it can be faster when the uncertainty regarding the appropriate power level is small. In this case, the interference caused by the second method can be lower than that caused by the first method.

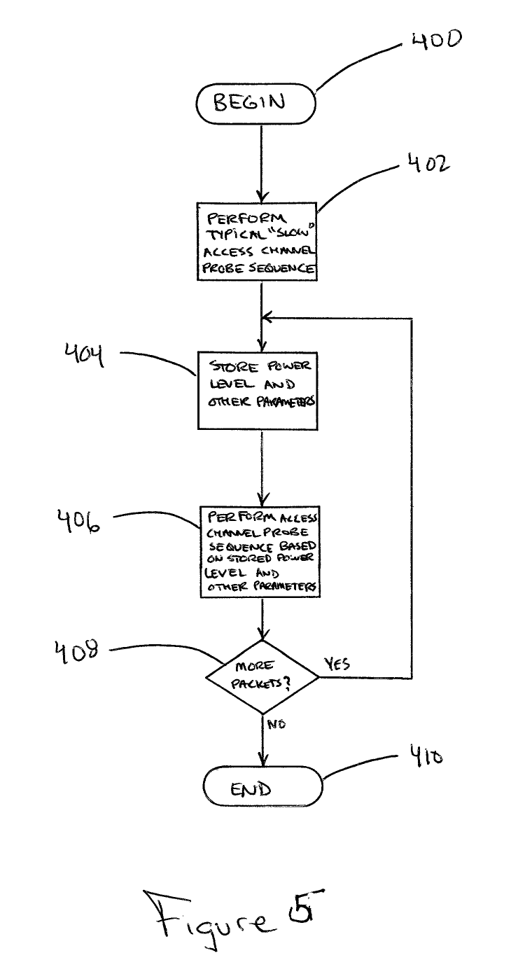

Referring now to FIG. 5, there is shown a flowchart diagram illustrating exemplary method steps that can be performed by a mobile station according to an embodiment of the present invention. At step 402, a typical “slow” access channel probe sequence is performed for a first packet (packet 1) in a sequence of packets. At step 404, the power level that was used to successfully obtain a response from the system for the first packet (packet 1) is stored. This step may also include storing a recently measured received code power (e.g., RSCP) and/or a recently measured interference level. At step 406, an access channel probe sequence is performed for a next packet (packet 1+n) in the sequence of packets based upon the transmitted power level that was used to successfully obtain a response from the system for the first packet (packet 1), the received code power that was measured just before the transmission of the next packet (packet 1+n), and/or the interference level that was measured just before the transmission of the next packet (packet 1+n). At step 408, the modified open loop power control method of the invention can be continued if there are more packets in the sequence of packets. Alternatively, the modified open loop power control method can be terminated if there are no additional packets in the sequence of packets.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

What is claimed is:

1. A method for improving open loop power control in spread spectrum telecommunications systems, the method comprising the steps of:
transmitting at least one first access channel probe for a first message from a mobile station to a base station, the transmission power level of each access channel probe in the at least one first access channel probe being increased until a base station acknowledgment is received for a specific access channel probe of the at least one first access channel probe at a first transmission power level;
storing the first transmission power level at the mobile station; and
transmitting at least one second access channel probe for a second message from the mobile station to the base station, the transmission power level of an initial access channel probe of the at least one second access channel probe for the second message being based upon the first transmission power level.

2. The method as defined in claim 1, further comprising the step of:
storing a recently measured received code power from the base station at the mobile station, the transmission power level of the initial access channel probe of the at least one second access channel probe for the second message being further based upon the recently measured received code power.

3. The method as defined in claim 1, further comprising the step of:
storing a recently measured base station interference level at the mobile station, the transmission power level of the initial access channel probe of the at least one second access channel probe for the second message being further based upon the recently measured base station interference level.

4. The method as defined in claim 1, wherein the first message is a first packet and the second message is a second packet in a packet mode transmission.

5. The method as defined in claim 1, wherein the transmission power level of an initial access channel probe of the at least one first access channel probe for the first message is based upon a path loss between the mobile station and the base station.

6. The method as defined in claim 5, wherein the transmission power level of an initial access channel probe of the at least one first access channel probe for the first message is further based upon a base station interference level.

7. The method as defined in claim 1, wherein the transmission power level of the initial access channel probe of the at least one second access channel probe for the second message is closer to the first transmission power level than a transmission power level of an initial access channel probe of the at least one first access channel probe for the first message.

8. The method as defined in claim 1, wherein the transmission power level of the initial access channel probe of the at least one second access channel probe for the second message is closer to a transmission power level that is required to have the initial access channel probe reach the base station than a transmission power level of an initial access channel probe of the at least one first access channel probe for the first message.

9. The method as defined in claim 1, wherein the transmission power level of the second message is at or slightly above a transmission power level that is required to have the second message reach the base station.

10. An apparatus for improving open loop power control in spread spectrum telecommunications systems, the apparatus comprising:
at least one memory for storing a first transmission power level of a specific access channel probe of at least one first access channel probe for a first message transmitted from a mobile station to a base station, the specific access channel probe of the at least one first access channel probe being the first access channel probe to receive an acknowledgment from the base station; and
at least one processor for determining a second transmission power level of an initial access channel probe of at least one second access channel probe for a second message to be transmitted from the mobile station to the base station, the second transmission power level of the initial access channel probe of the at least one second access channel probe for the second message being determined based upon first transmission power level.

11. The apparatus as defined in claim 10, wherein the memory also stores a recently measured received code power from the base station, the second transmission power level of the initial access channel probe of the at least one second access channel probe for the second message being further based upon the recently measured received code power.

12. The apparatus as defined in claim 10, wherein the memory also stores a recently measured base station interference level, the second transmission power level of the initial access channel probe of the at least one second access channel probe for the second message being further based upon the recently measured base station interference level.

13. The apparatus as defined in claim 10, wherein the first message is a first packet and the second message is a second packet in a packet mode transmission.

14. The apparatus as defined in claim 10, wherein the transmission power level of an initial access channel probe of the at least one first access channel probe for the first message is based upon a path loss between the mobile station and the base station.

15. The apparatus as defined in claim 14, wherein the transmission power level of an initial access channel probe of the at least one first access channel probe for the first message is further based upon a base station interference level.

16. The apparatus as defined in claim 10, wherein the second transmission power level of the initial access channel probe of the at least one second access channel probe for the second message is closer to the first transmission power level than a transmission power level of an initial access channel probe of the at least one first access channel probe for the first message.

17. The apparatus as defined in claim 10, wherein the second transmission power level of the initial access channel probe of the at least one second access channel probe for the second message is closer to a transmission power level that is required to have the initial access channel probe reach the base station than a transmission power level of an initial access channel probe of the at least one first access channel probe for the first message.

18. The apparatus as defined in claim 10, wherein the second transmission power level of the initial access channel probe of the at least one second access channel probe for the second message is at or slightly above a transmission power level that is required to have the initial access channel probe reach the base station.

19. An article of manufacture for improving open loop power control in spread spectrum telecommunications systems, the article of manufacture comprising:
at least one processor readable carrier; and
instructions carried on the at least one carrier;
wherein the instructions are configured to be readable from the at least one carrier by at least one processor and thereby cause the at least one processor to operate so as to:
transmit at least one first access channel probe for a first message from a mobile station to a base station, the transmission power level of each access channel probe in the at least one first access channel probe being increased until a base station acknowledgment is received for a specific access channel probe of the at least one first access channel probe at a first transmission power level;
store the first transmission power level at the mobile station; and
transmit at least one second access channel probe for a second message from the mobile station to the base station, the transmission power level of an initial access channel probe of the at least one second access channel probe for the second message being based upon the first transmission power level.

20. The article of manufacture as defined in claim 19, further causing the at least one processor to operate so as to:
store a recently measured received code power from the base station at the mobile station, the transmission power level of the initial access channel probe of the at least one second access channel probe for the second message being further based upon the recently measured received code power.

21. The article of manufacture as defined in claim 19, further causing the at least one processor to operate so as to:
store a recently measured base station interference level at the mobile station, the transmission power level of the initial access channel probe of the at least one second access channel probe for the second message being further based upon the recently measured base station interference level.

22. The article of manufacture as defined in claim 19, wherein the first message is a first packet and the second message is a second packet in a packet mode transmission.

23. The article of manufacture as defined in claim 19, wherein the transmission power level of an initial access channel probe of the at least one first access channel probe for the first message is based upon a path loss between the mobile station and the base station.

24. The article of manufacture as defined in claim 23, wherein the transmission power level of an initial access channel probe of the at least one first access channel probe for the first message is further based upon a base station interference level.

25. The article of manufacture as defined in claim 19, wherein the transmission power level of the initial access channel probe of the at least one second access channel probe for the second message is closer to the first transmission power level than a transmission power level of an initial access channel probe of the at least one first access channel probe for the first message.

26. The article of manufacture as defined in claim 19, wherein the transmission power level of the initial access channel probe of the at least one second access channel probe for the second message is closer to a transmission power level that is required to have the initial access channel probe reach the base station than a transmission power level of an initial access channel probe of the at least one first access channel probe for the first message.

27. The article of manufacture as defined in claim 19, wherein the transmission power level of the initial access channel probe of the at least one second access channel probe for the second message is at or slightly above a transmission power level that is required to have the initial access channel probe reach the base station.
